(19) United States
(12) Patent Application Publication
(10) Pub. No.: US 2026/0180243 A1
(43) Pub. Date: Jun. 25, 2026

(54) MINIATURIZED MULTIPOLE PLUG AND RECEPTACLE

(71) Applicant: ESTRON A/S, Them (DK)

(72) Inventor: Carit LAURSEN, Them (DK)

(73) Assignee: ESTRON A/S, Them (DK)

(21) Appl. No.: 19/127,534

(22) PCT Filed: Oct. 16, 2023
(86) PCT No.: PCT/EP2023/078679

§ 371 Date: May 6, 2025

(30) Foreign Application Priority Data
Nov. 8, 2022 (EP) 22205982.6

(51) Int. Cl. H01R 13/58; H01R 12/72; H01R 13/02; H01R 13/436; H01R 13/502; H01R 13/52

(52) U.S. Cl. CPC H01R 13/58; H01R 12/721; H01R 13/025; H01R 13/4367; H01R 13/502; H01R 13/5202

(57) ABSTRACT

A multipole plug, a multipole receptacle, and a system including-a multipole plug and a multipole receptacle.

The invention relates to a miniaturized multipole plug and receptacle, and a miniaturized multipole system comprising the two parts.

### BACKGROUND

Electrical connectors are used almost in every possible industry, where two objects need to be electrically connected. In applications, e.g. hearing aids, ear monitors used in the security, TV, and music industry and similar, where space and appearance are of big importance and the size of the electrical connectors needs to be small in order to fit into e.g. electrical devices. Examples of such connectors are the commonly known micro and mini jack connectors, which are used in e.g. cell phones, mp3 players or the like for connecting earphones with the device.

However, common for the electrical connectors is that there is a need for more robust plug and receptacle solutions.

### SUMMARY

Disclosed herein is a multipole plug configured for making electrical contact with parts in a corresponding multipole receptacle when the multipole plug and the multipole receptacle are connected.

The multipole plug is normally comprising:
a non-conducting plug housing having a front end opening and a rear end opening;
a cable strain relief extending though the rear end opening of the plug housing, the cable strain relief comprising a through-going relief opening configured for having a cable extending there through;
a plurality of upper conducting poles configured for making electrical contact with a plurality of receptacle upper conducting arms of the multipole receptacle;
a plurality of lower conducting poles configured for making electrical contact with a plurality of receptacle lower conducting arms of the multipole receptacle;
a plug plate extending through the front end opening of the plug housing, wherein the plug plate is substantially flat and comprises:
   a non-conducting top layer supporting the plurality of upper conducting poles;
   a non-conducting bottom layer supporting the plurality of lower conducting poles;
   a maximum plug plate length extending from a front end of the plug plate to a rear end of the plug plate;
   a maximum plug plate width extending from a first side of the plug plate to an opposite second side of the plug plate;
   a maximum plug plate height extending between the top layer and the bottom layer.

In a first aspect of the multipole plug, the front end opening of the plug housing is tapered inwardly thereby creating a funnel plug plate connection section, which funnels rearwardly in the front end opening. This provides an ecstatically more attractive appearance of the plug. Further, during assembly of the plug, the inwardly funnel shape provides an increased control of the material in the interface between the plug housing front end opening and the plug plate. For example, when assembling the plug plate and the plug housing, soldering, adhesion or similar may be used in order to provide an air and dust tight connection. By having a front end opening of the plug housing being tapered inwardly, soldering/adhesive material may be positioned within the funnel such that the excess soldering/adhesive material does not extend outside the funnel plug plate connection section.

In a second aspect of the multipole plug, the plug plate further comprises a side recess section with a recess plug plate width being smaller than the maximum plug plate width. The side recess section is normally configured for being engaged by a receptacle spring in the multipole receptacle thereby securing the multipole plug in the multipole receptacle. This provides a very robust fixation function, where the plug plate also has a securing function apart from supporting the conducting poles. The plug and the receptacle may therefore be assembled/dissembled a significantly larger number of times compared to plug and receptacle systems, where the securing and locking function is provided in the conducting parts.

In a third aspect of the multipole plug, the plug housing comprises a plug housing front section configured for being positioned inside a receptacle housing when the multipole plug and the multipole receptacle are connected, wherein the plug plate extends through the plug housing front section dividing the plug housing front section into a bottom plug housing front section extending below the plug plate and a top plug housing front section extending above the plug plate. The bottom plug housing front section part has a peripheral bottom plug housing curvature being different from a peripheral top plug housing curvature of the top plug housing front section part thereby giving the plug housing front section an asymmetrical periphery. The asymmetry ensures that the multipole plug cannot be inserted into the multipole receptacle if it is turned 180 degrees as compared to the correct orientation of the multipole plug. The upper and lower conducting poles may therefore be assigned different functionalities as the asymmetrical periphery of the plug housing ensures that the upper conducting poles on the plug plate are only able to electrically connect to the upper conducting arms in the receptacle, and that the lower conducting poles on the plug plate are only able to electrically connect to the lower conducting arms in the receptacle. The asymmetry ensuring that the plug and the receptacle can only be connected if turned correctly is therefore not a feature of the fragile conducting parts in the plug and the receptacle, but in the much more stable non-conducting plug housing.

In a fourth aspect of the multipole plug, the plug plate comprises a conductive middle layer positioned between the top surface and bottom surface. The multipole plug further comprises the cable extending through the through-going relief opening of the cable strain relief. The cable comprises a plurality of wires configured for being connected to the plurality of upper conducting poles and the plurality of lower conducting poles, thereby creating an electrical connection. The cable also comprises at least one conductive outer shield layer forming an electrical shield from the plurality of wires, the at least one conductive outer layer connected to the conductive middle layer of the plug plate, thereby creating an electrical connection. The upper and lower conducting poles may be configured for making electrical contact with a plurality of conducting arms in a multipole receptacle when the multipole plug is connected to the multipole receptacle. The conductive middle layer of the plug plate may be configured for making electrical contact with a conductive spring in the multipole receptacle when the multipole plug is connected to the multipole receptacle. This ensures an additional electrical connection between the multipole plug and the multipole receptacle when connected. The additional electrical layer may also act as an electrical ground layer connection.

The electrical connection between the conductive outer shield layer and the conductive middle layer of the plug plate may be a mechanically created press fitting connection, through a tinning process or created by using a conductive adhesive.

In one or more examples of the of the multipole plug according to the first aspect or the second aspect or the fourth aspect, the plug housing comprises a plug housing front section configured for being positioned inside a receptacle housing when the multipole plug and the multipole receptacle are connected, wherein the plug plate extends through the plug housing front section dividing the plug housing front section into a bottom plug housing front section extending below the plug plate and a top plug housing front section extending above the plug plate. The bottom plug housing front section part has a peripheral bottom plug housing curvature being different from a peripheral top plug housing curvature of the top plug housing front section part thereby giving the plug housing front section an asymmetrical periphery.

Also, in one or more examples of the of the multipole plug according to the first aspect or the third aspect or the fourth aspect, the plug plate further comprises a side recess section with a recess plug plate width being smaller than the maximum plug plate width and configured for being engaged by a receptacle spring in the multipole receptacle thereby securing the multipole plug in the multipole receptacle.

Further, in one or more examples of the of the multipole plug according to the second aspect or the third aspect or the fourth aspect, the front end opening of the plug housing is tapered inwardly thereby creating a funnel plug plate connection section which funnels rearwardly in the front end opening.

Additionally, in one or more examples of the of the multipole plug according to the first aspect or the second aspect or the third aspect, the plug plate comprises a conductive middle layer positioned between the top surface and bottom surface. The multipole plug further comprises the cable extending through the through-going relief opening of the cable strain relief. The cable comprises a plurality of wires configured for being connected to the plurality of upper conducting poles and the plurality of lower conducting poles, thereby creating an electrical connection. The cable also comprises at least one conductive outer shield layer forming an electrical shield from the plurality of wires, the at least one conductive outer layer connected to the conductive middle layer of the plug plate, thereby creating an electrical connection. The upper and lower conducting poles may be configured for making electrical contact with a plurality of conducting arms in a multipole receptacle when the multipole plug is connected to the multipole receptacle. The conductive middle layer of the plug plate may be configured for making electrical contact with a conductive spring in the multipole receptacle when the multipole plug is connected to the multipole receptacle.

Thus, the details of the multipole plug defined in any of the first, second, third, and fourth aspects of the multipole plug may be combined together two and two, three and three or all four options combined.

In one or more examples, the bottom front section part of the plug housing is thicker than the top front section part of the plug housing. This further enhances the asymmetry of the plug housing and ensured that the plug is always inserted into the receptacle turned correctly.

In one or more examples, the plug plate further comprises a middle layer positioned between the top surface and bottom surface, the middle section being a reinforcement layer providing stability to the plug plate. Including the reinforcement layer in the plug plate in a sandwich type structure provides additional strength to the plug plate. The reinforcement layer may be a metal reinforcement layer. A metal reinforcement layer is not influencing the conducting parts of the plug plate, since the reinforcement layer is positioned between the two non-conducting materials constituting the top layer and the bottom layer of the plug plate.

The plug housing may comprise a plug housing rear end section and a plug housing front section, wherein an O-ring is positioned between the plug housing rear end section and the plug housing front section for providing a tight fit between the plug housing front section positioned inside the multipole receptacle.

The non-conducting parts in the plug may be plastic parts.

In one or more examples, the plug further comprising a cable comprising a plurality of wires configured for being connected to the plurality of upper conducting poles and the plurality of lower conducting poles. Thus, the number of wires will normally match the number of upper and lower conducting poles.

The plug housing and plug plate may have a combined length of less than 15.0 mm, such as less than 12.0 mm, such as less than 10.0 mm, such as less than 9.0 mm, such as 8.35 mm.

The plug housing may have a maximum plug housing height of less than 6 mm, such as less than 5 mm, such as less than 4 mm, such as 3.80 mm.

The plug housing may have a maximum plug housing width of less than 7.0 mm, such as less than 6.0 mm, such as less than 5.0 mm, such as 4.9 mm.

The maximum plug plate length may be less than 10.0 mm, such as less than 8.0 mm, such as less than 6.0 mm, such as less than 5.0 mm.

The maximum plug plate width may be less than 7.0 mm, such as less than 6.0 mm, such as less than 5.0 mm, such as less than 4.0 mm, such as less than 3.0 mm.

The maximum plug plate height may be less than 2.0 mm, such as less than 1.5 mm, such as less than 1.0 mm, such as less than 0.5 mm, such as less than 0.4 mm.

The multipole plug may thus be a miniaturized multipole plug.

In one or more examples, the number of the plurality of upper conducting poles is at least four and the number of the plurality of lower conducting poles is at least four. Five, six, seven, eight or more upper conducting poles and lower conducting poles may also be imagined.

Disclosed herein is also a multipole receptacle configured for making electrical contact with parts in a corresponding multipole plug when the multipole plug and the multipole receptacle are connected, the multipole receptacle comprising:
a receptacle housing comprising a front end opening and a rear end opening;
a plurality of upper conducting arms configured for making electrical contact with a plurality of upper conducting poles of the multipole plug;
a plurality of lower conducting arms configured for making electrical contact with a plurality of lower conducting poles of the multipole plug;
a receptacle insulator plate positioned in the rear end opening of the receptacle housing, the receptacle insulator plate comprising:
   at least one upper plate opening through which the upper conducting arms extends;
   at least one lower plate opening through which the lower conducting arms extends.

In a first aspect of the multipole receptacle, the multipole receptacle further comprises a spring secured in a spring recess in the receptacle insulator plate, the spring extending towards the front end opening of the receptacle housing, the spring being configured for securing the multipole plug inside the multipole receptacle. This provides a very robust fixation function, where the spring has the securing function. The plug and the receptacle may therefore be assembled/dissembled a significantly larger number of times compared to plug and receptacle systems, where the securing and locking function is provided in the conducting parts.

In a second aspect of the multipole receptacle, the receptacle housing comprises a receptacle housing front section inside which a plug housing front section is positioned when the multipole plug and the multipole receptacle are connected, the receptacle housing front section having an inner peripheral surface with a top receptacle housing curvature being different from a bottom receptacle housing curvature thereby giving the inner housing front section an asymmetrical inner periphery. The asymmetry ensures that a multipole plug cannot be inserted into the multipole receptacle if it is turned 180 degrees as compared to the correct orientation of the multipole plug. The upper and lower conducting arms of the receptacle may therefore be assigned different functionalities as the asymmetrical periphery of the receptacle housing ensures that the upper conducting poles on the plug plate are only able to electrically connect to the upper conducting arms in the receptacle, and that the lower conducting poles on the plug plate are only able to electrically connect to the lower conducting arms in the receptacle. The asymmetry ensuring that the plug and the receptacle can only be connected if turned correctly is therefore not a feature of the fragile conducting parts in the plug and the receptacle, but in the much more stable non-conducting plug housing.

In a third aspect of the multipole receptacle, the multipole receptacle further comprises a conducting spring secured in a spring recess in the receptacle insulator plate. The multipole receptacle also comprises a receptacle cable or a printed circuit board.

The receptacle cable may comprise a plurality of receptacle wires configured for being connected to the plurality of upper conducting arms and the plurality of lower conducting arms, thereby creating an electrical connection. The receptacle cable may further comprise at least one spring conductive shield layer shielded from the plurality of receptacle wires and connected to the spring, thereby creating an electrical connection.

The printed circuit board comprise a plurality of connection points configured for being connected to the plurality of upper conducting arms, the plurality of lower conducting arms, and the spring, thereby creating an electrical connection.

By the above is ensured an additional electrical connection between the multipole plug and the multipole receptacle when connected. The additional electrical connection may ensure a connection to an electrical ground layer of the multipole plug and an electrical spring connection of the multipole receptacle. The electrical ground layer may be connected to a shield of the cable.

The electrical connection between the spring conductive shield layer and the spring may be a mechanically created press fitting connection, through a tinning process or created by using a conductive adhesive.

In one or more examples of the of the multipole receptacle according to the first aspect or the third aspect, the receptacle housing comprises a receptacle housing front section inside which a plug housing front section is positioned when the multipole plug and the multipole receptacle are connected, the receptacle housing front section having an inner peripheral surface with a top receptacle housing curvature being different from a bottom receptacle housing curvature thereby giving the inner housing front section an asymmetrical inner periphery.

In one or more examples of the of the multipole receptacle according to the second aspect or the third aspect, the multipole receptacle further comprising a spring secured in a spring recess in the receptacle insulator plate, the spring extending towards the front end opening of the receptacle housing, the spring being configured for securing the multipole plug inside the multipole receptacle.

In one or more examples of the of the multipole receptacle according to the first aspect or the second aspect, the multipole receptacle further comprises a conducting spring secured in a spring recess in the receptacle insulator plate. The multipole receptacle also comprises a receptacle cable or a printed circuit board.

The receptacle cable may comprise a plurality of receptacle wires configured for being connected to the plurality of upper conducting arms and the plurality of lower conducting arms, thereby creating an electrical connection. The receptacle cable may further comprise at least one spring conductive shield layer shielded from the plurality of receptacle wires and connected to the spring, thereby creating an electrical connection.

The printed circuit board comprise a plurality of connection points configured for being connected to the plurality of upper conducting arms, the plurality of lower conducting arms, and the spring, thereby creating an electrical connection.

Thus, the details of the multipole receptacle defined in the first and second and third aspects of the multipole receptacle may be combined together two and two or all three options combined.

In one or more examples, the upper conducting arms are closer to an inner upper wall of receptacle housing than the lower conducting arms are to an inner lower wall. This further enhances the asymmetry of the plug housing and ensured that the plug is always inserted into the receptacle turned correctly.

In one or more examples, the receptacle insulator plate further comprises:
at least one upper plate support surface, wherein a rear end of each upper conducting arm is secured between the least one upper plate support surface and the receptacle housing;
at least one lower plate support surface, wherein a rear end of each lower conducting arm is secured between the least one lower plate support surface and the receptacle housing;
   wherein a front end of each upper conducting arm and a front end of each lower conducting arm are able to flex away from each other when the plug plate of the multipole plug is inserted between the upper conducting arms and the lower conducting arms when connecting the multipole plug and the multipole receptacle.

This provides for a very stable system securing each conducting arm in the receptacle at the same time as ensuring that each conducting arm is able to flex.

Between the conducting arms may be found a number of receptacle housing separation parts. Bottom receptacle housing separation parts normally separate each of the lower conducting arms. Top receptacle housing separation parts normally separate each of the upper conducting arms. The receptacle housing separation parts provides side-way stability to the conducting arms. The receptacle housing separation parts also ensures that the conducting arms do not come in electrical contact with each other. The receptacle housing separation parts are normally part of the receptacle housing. Alternatively, the receptacle housing separation parts could be a separate item.

The receptacle housing may have a maximum length of less than 15 mm, such as less than 12 mm, such as less than 10 mm, such as less than 8 mm, such as 7.55 mm.

The receptacle housing may have a maximum height of less than 7 mm, such as less than 6 mm, such as less than 5 mm, such as 4.00 mm.

The receptacle housing may have a maximum width of less than 9 mm, such as less than 8 mm, such as less than 7 mm, such as less than 6 mm, such as 5.30 mm.

The multipole receptacle may thus be a miniaturized multipole receptacle.

Disclosed herein in is further a multipole system comprising a multipole plug and a multipole receptacle. The plurality of upper conducting poles of the multipole plug may be configured for making electrical contact with the plurality of upper conducting arms of the multipole receptacle, and the plurality of lower conducting poles may be configured for making electrical contact with the plurality of lower conducting arms of the multipole receptacle when the multipole plug and the multipole receptacle are connected.

### BRIEF DESCRIPTION OF THE DRAWINGS

Various examples are described hereinafter with reference to the figures. Like reference numerals refer to like elements throughout. Like elements will, thus, not be described in detail with respect to the description of each figure. It should also be noted that the figures are only intended to facilitate the description of the examples. They are not intended as an exhaustive description of the claimed invention or as a limitation on the scope of the claimed invention. In addition, an illustrated example needs not have all the aspects or advantages shown. An aspect or an advantage described in conjunction with a particular example is not necessarily limited to that example and can be practiced in any other examples even if not so illustrated, or if not so explicitly described.

FIGS. 1A-1E show a multipole plug in an exploded view (FIG. 1A), a front view (FIG. 1B), a side cut-through view (FIG. 1C), a top-down view (FIG. 1D), and a side view (FIG. 1E).

FIG. 2A shows a top-down view of a connector plate in the multipole plug and FIG. 2B show a bottom-up view of the connector plate.

FIGS. 3A-3F show a multipole receptacle in an exploded view (FIG. 3A), a front view (FIG. 3B), a rear-end view (FIG. 3C), a top-down cut-through view (FIG. 3D), a side cut-through view (FIG. 3E), and a side-front view (FIG. 3F).

FIGS. 4A-4B show the multipole plug of FIG. 1A-1E connected with the multipole receptacle of FIGS. 3A-3F in a top-down cut-through view (FIG. 4A) and a side cut-through view (FIG. 4B).

FIGS. 5A-C show an alternative example of the multipole plug in an exploded view (FIG. 5A), a top-down view (FIG. 5B), and a side view (FIG. 5C).

FIG. 6 shows a connected multipole plug and receptacle system with the multipole plug of FIG. 5A-C and the multipole receptacle of FIGS. 3A-3F in side cut-through view.

FIG. 7A show yet an alternative example of the multipole plug in an exploded view.

FIG. 7B shows an alternative example of the multipole receptacle in an exploded view.

FIGS. 7C-E show the multipole plug of FIG. 7A connected with the multipole receptacle of FIG. 7B in a side cut-through view (FIG. 7C), a sideways-top view where the outer housing parts have been omitted (FIG. 7D), and a sideways-bottom view where the outer housing parts have been omitted (FIG. 7E).

### DESCRIPTION OF EXAMPLES

Exemplary examples will now be described more fully hereinafter with reference to the accompanying drawings. In this regard, the present examples may have different forms and should not be construed as being limited to the descriptions set forth herein. Accordingly, the examples are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

In the drawings, thicknesses of a plurality of layers and areas are illustrated in an enlarged manner for clarity and ease of description thereof. When a layer, area, element, or plate is referred to as being “on” another layer, area, element, or plate, it may be directly on the other layer, area, element, or plate, or intervening layers, areas, elements, or plates may be present therebetween. Conversely, when a layer, area, element, or plate is referred to as being “directly on” another layer, area, element, or plate, there are no intervening layers, areas, elements, or plates therebetween. Further when a layer, area, element, or plate is referred to as being “below” another layer, area, element, or plate, it may be directly below the other layer, area, element, or plate, or intervening layers, areas, elements, or plates may be present therebetween. Conversely, when a layer, area, element, or plate is referred to as being “directly below” another layer, area, element, or plate, there are no intervening layers, areas, elements, or plates therebetween.

The spatially relative terms “lower” or “bottom” and “upper” or “top”, “below”, “beneath”, “less”, “above”, and the like, may be used herein for ease of description to describe the relationship between one element or component and another element or component as illustrated in the drawings. It will be understood that the spatially relative terms are intended to encompass different orientations of the device in use or operation, in addition to the orientation depicted in the drawings. For example, in the case where a device illustrated in the drawings is turned over, elements described as being on the “lower” side of other elements, or “below” or “beneath” another element would then be oriented on “upper” sides of the other elements, or “above” another element. Accordingly, the illustrative term “below” or “beneath” may include both the “lower” and “upper” orientation positions, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below, and thus the spatially relative terms may be interpreted differently depending on the orientations described.

Throughout the specification, when an element is referred to as being “connected” to another element, the element is “directly connected” to the other element, or “electrically connected” to the other element with one or more intervening elements interposed therebetween.

The terminology used herein is for the purpose of describing particular examples only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 50%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined in the present specification.

Exemplary examples are described herein with reference to cross section illustrations that are schematic illustrations of idealized examples, wherein like reference numerals refer to like elements throughout the specification. As such, variations from the shapes of the illustrations as a result, for example, of manufacturing techniques and/or tolerances, are to be expected. Thus, examples described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. Some of the parts which are not associated with the description may not be provided in order to specifically describe exemplary examples of the present disclosure.

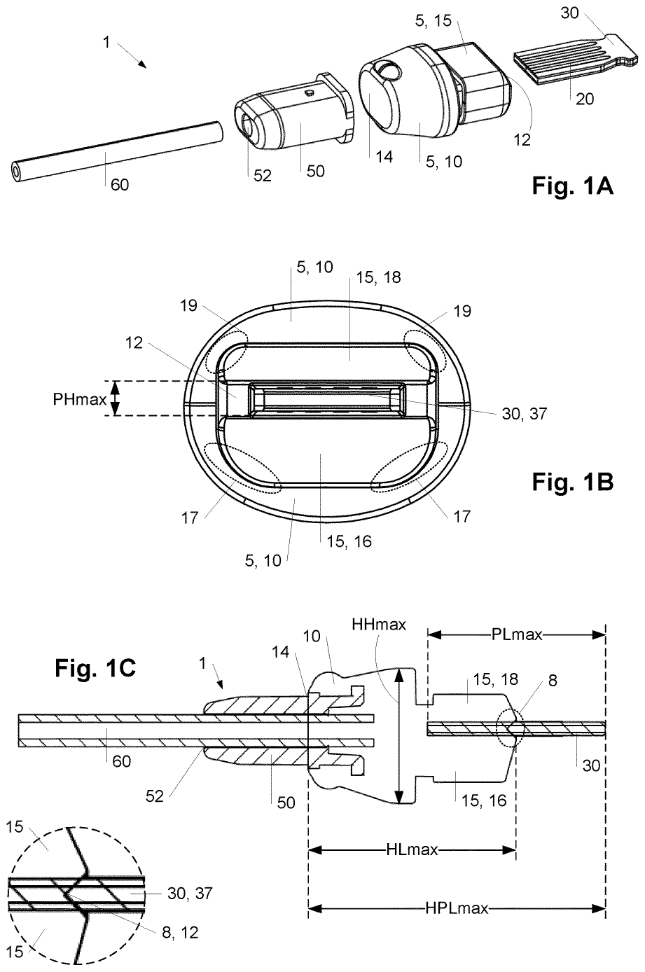

FIGS. 1A-1E show a multipole plug 1 in different views with FIG. 1A being an exploded view, FIG. 1B being a front view, FIG. 1C being a side cut-through view, FIG. 1D being a top-down view, and FIG. 1E being a side view. The plug housing 5 comprises a front end opening 12 and a rear end opening 14. The plug 1 also comprises a plug housing 5 with a plug housing front section 15 and a plug housing rear end section 10. When referring to front end is meant the end of the plug engaging with the receptacle. When referring to the rear end, the end facing away from the front end is meant. The plug housing front section 15 is configured for being positioned inside a receptacle housing when the multipole plug 1 and the multipole receptacle 100 are connected. The plug housing front section 15 has a bottom plug housing front section 16 extending below the front end opening 12 and a top plug housing front section 18 extending above the front end opening 12. This can be seen in FIG. 1B. The bottom plug housing front section part 16 has a peripheral bottom plug housing curvature 17 as marked in FIG. 1B. Likewise, the top plug housing front section part 18 has a peripheral top plug housing curvature 19. The two curvatures are different, which give the plug housing front section 15 an asymmetrical periphery. The asymmetry ensures that the plug 1 cannot be inserted into the receptacle 100 if it is turned 180 degrees as compared to the correct orientation of the plug 1. Further, the bottom front section part 16 is thicker, i.e. has a larger height than the top front section part 18. This increases the asymmetry of the plug 1.

The maximum dimensions of the plug housing 5 are marked in FIGS. 1C and 1D. By maximum is meant the largest length (L), height (H) and width (W) of the plug housing. A typical maximum plug housing height (HHmax) is less than 6 mm, such as less than 5 mm, such as less than 4 mm, such as 3.80 mm. A typical maximum plug housing width (HWmax) is less than 7.0 mm, such as less than 6.0 mm, such as less than 5.0 mm, such as 4.9 mm. A typical maximum plug housing length (HLmax) is less than 12 mm, such as less than 10 mm, such as less than 8 mm, such as less than 6 mm.

Through the rear end opening 14 of the plug housing 5 is a cable strain relief 50. The cable strain relief 50 comprises a through-going relief opening 52, which is seen in e.g. FIG. 1C. A cable 60 extending there through. The cable strain relief 50 provides stability to the cable 60. The cable 60 creates an electrical connection to conducting poles 20, 24 in the plug 1.

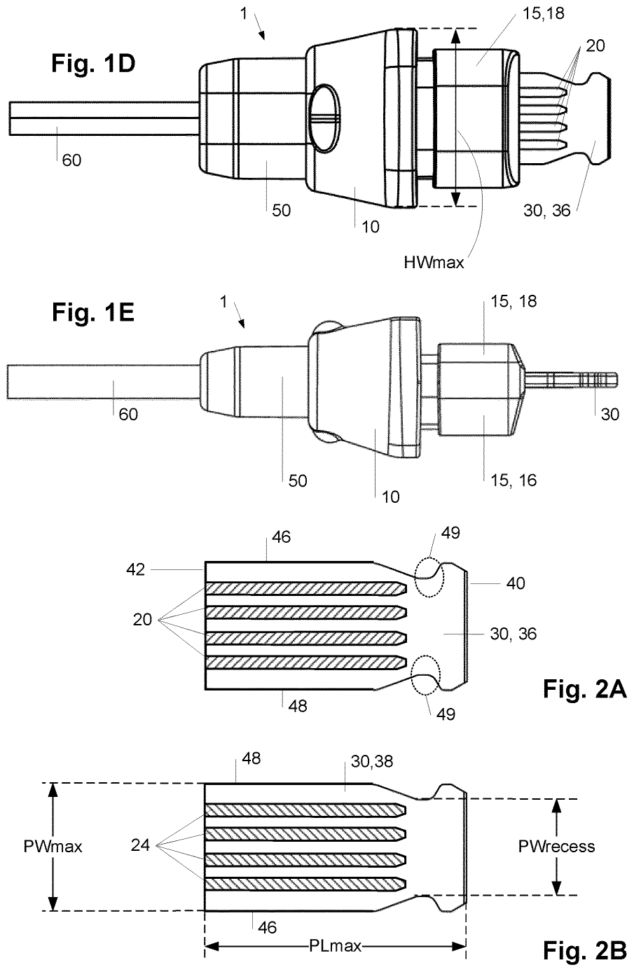

A plug plate 30 extends through the front end opening 12 of the plug housing 5. The plug plate is shown in a close-up from the top and from the bottom in FIGS. 2A and 2B, respectively. By top and upper are meant the side/parts pointing upwards as shown in the figures and by bottom and lower are meant the side/parts pointing downwards as shown in the figures. The plug plate 30 supports a number of conducting poles 20, 24 configured for making electrical connection with corresponding receptacle parts 120, 124. Normally, the poles 20, 24 will be printed onto the surfaces of the plug plate 30. The plug plate is substantially flat. The plug plate comprises a non-conducting top layer 36 supporting a plurality of upper conducting poles 20. The plug plate further comprises a non-conducting bottom layer 38 supporting a plurality of lower conducting poles 24. Thus, normally there will be conducting poles on both main surfaces of the plug plate 30. Since the plug housing 5 is asymmetrical, the number of upper lower conducting poles 20 need not be the same as the number of the lower conducting poles 24. Likewise, the electrical connection and purpose of the upper lower conducting poles 20 need not be the same as the that of the lower conducting poles 24. This allows for individual use of each conducting pole.

The maximum dimensions of the plug plate 30 are marked in FIGS. 1C and 2B. By maximum is meant the largest length (L), height (H) and width (W) of the plug plate 30. The maximum plug plate length (PLmax) is extending from a front end 40 of the plug plate 30 to a rear end 42 of the plug plate 30. The maximum plug plate length (PLmax) is typically less than 10.0 mm, such as less than 8.0 mm, such as less than 6.0 mm, such as less than 5.0 mm. The maximum plug plate width (PWmax) is extending from a first side 46 of the plug plate 30 to an opposite second side 48 of the plug plate 30. The maximum plug housing width (HWmax) is typically less than 7.0 mm, such as less than 6.0 mm, such as less than 5.0 mm, such as 4.9 mm. The maximum plug plate height (PHmax) is extending between the top layer 36 and the bottom layer 38. The maximum plug plate height (PHmax) is typically less than 2.0 mm, such as less than 1.5 mm, such as less than 1.0 mm, such as less than 0.5 mm, such as less than 0.4 mm.

As shown most clearly in FIGS. 2A-B, the plug plate 30 further comprises a side recess section 49. The width of the plug plate 30 at the side recess section 49 referred to as a recess plug plate width (PWrecess) is smaller than the maximum plug plate width (PWmax). The side recess section 49 is configured for being engaged by a receptacle spring in the multipole receptacle 100 thereby securing the multipole plug 1 in the multipole receptacle 100. The plug plate 30 thus also has a securing function apart from supporting the conducting poles 20, 24.

The number of the upper and lower conducting poles 20, 24 is shown as being four each. However, the number may be higher or lower and may be different depending on which side the poles are on.

The plug plate 30 further comprises a middle layer 37 positioned between the top surface 36 and bottom surface 38. The middle section 37 is marked in FIG. 1B. The middle section 37 is a reinforcement layer, which provides stability and strength to the plug plate 30. The reinforcement layer 37 may be a metal reinforcement layer. Including the reinforcement layer 37 in the plug plate 30 in a sandwich type structure provides additional strength to the plug plate 30 without influencing the conducting parts, since the reinforcement layer 37 is positioned between two non-conducting materials constituting the top layer 36 and the bottom layer 38 of the plug plate 30.

The front end opening 12 of the plug housing 5 is tapered inwardly as shown in FIG. 1C (see the enlarged view in the left corner). This creates a funnel plug plate connection section 8, which funnels rearwardly in the front end opening 12. During assembly of the plug 1, the inwardly funnel shape provides an increased control of the material in the interface between the plug housing front end opening 12 and the plug plate 30.

As shown in FIG. 1E, the plug plate 30 is positioned in an upper section of the plug housing front section 15 of the plug housing 5 due to the asymmetrical position of the front end opening 12.

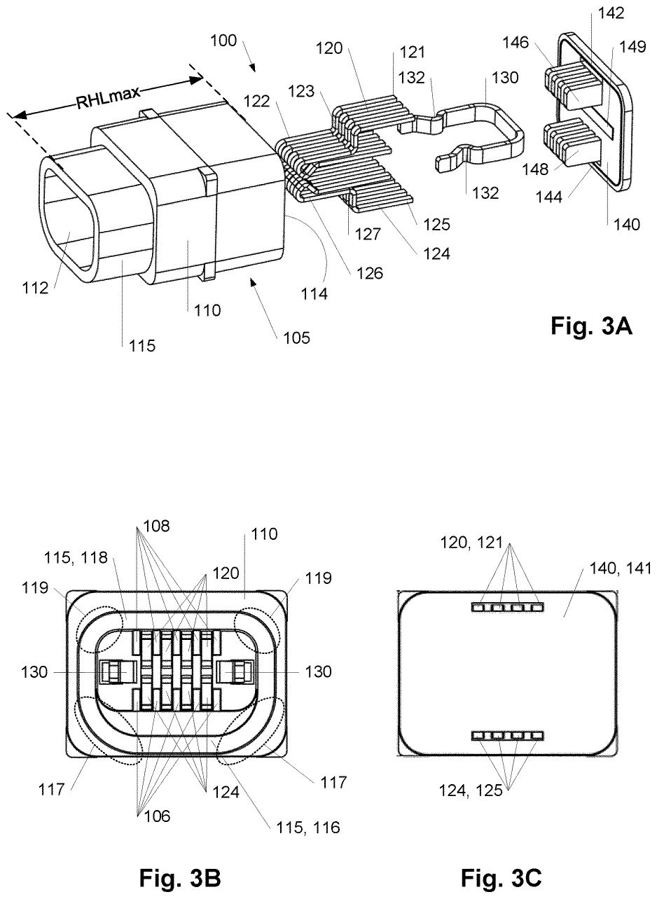

FIGS. 3A-3F show a multipole receptacle 100. The multipole receptacle 100 is configured for making electrical contact with parts in a corresponding multipole plug 1 as shown in FIGS. 1A-1E when the multipole plug 1 and the multipole receptacle 100 are connected. The multipole receptacle 100 comprises a receptacle housing 105. The receptacle housing 105 has a front end opening 112 and a rear end opening 114. The receptacle housing 105 has a receptacle housing front section 115 and a receptacle housing rear end section 110. During assembly of the plug 1 and the receptacle 100, the plug housing front section 15 is positioned inside the receptacle housing front section 115. The receptacle housing front section 115 comprises a bottom receptacle housing front section 116 and a top plug housing front section 118 as shown in FIGS. 3B and 3E. The receptacle housing front section 115 also comprises an inner peripheral surface with a top receptacle housing curvature 119 and a bottom receptacle housing curvature 117. Mirroring the shape of the plug housing front section 15, the top receptacle housing curvature 119 and the bottom receptacle housing curvature 117 are different. The inner periphery surface of the receptacle housing front section 15 is therefore asymmetrical matching that of the plug housing front section 15.

The inside surface of the receptacle housing front section 115 can also be divided into an inner lower wall 107 and an inner upper wall 109 as shown in FIG. 3E.

The receptacle 100 further comprises a number of conducting arms 120, 124 arranged in two groups; a plurality of upper conducting arms 120 and a plurality of lower conducting arms 124. The conducting arms 120, 124 are configured for making electrical contact with the conducting poles 20, 24 in the multipole plug 1 when the plug 1 and the receptacle 100 are connected. As shown in FIGS. 3A and 3E, the conducting arms 120, 124 extends forward in an approximately straight line in two sections and has a section in between, where the conducting arms 120, 124 bends in a direction towards each other and substantially perpendicular to the straight direction sections. The bended structure of the conducting arms 120, 124 are supported by a receptacle insulator plate 140. The receptacle insulator plate 140 is positioned in the rear end opening 114 of the receptacle housing 105. The receptacle insulator plate 140 comprises an upper plate opening 142 through which the upper conducting arms 120 extends, and a lower plate opening 144 through which the lower conducting arms 124 extends. The rear end surface 141 of the receptacle insulator plate 140 with rear ends 121, 125 of the conducting arms 120, 124 extending there through can be seen in FIG. 3C.

The receptacle insulator plate 140 comprises a number of upper plate support surfaces 146. A rear end 121 of each upper conducting arm 120 rests on top of one of the upper plate support surfaces 146 as shown in FIG. 3E. On the upper side of the conducting arms 120 are the inside of the receptacle housing 105. The rear end 121 of each of the upper conducting arm 120 is thereby secured between one upper plate support surface 146 and the receptacle housing 105. Likewise, the receptacle insulator plate 140 comprises a number of lower plate support surfaces 148. A rear end 125 of each lower conducting arm 124 rests on top of one of the lower plate support surfaces 148 as also shown in FIG. 3E. On the lower side of the conducting arms 124 are the inside of the receptacle housing 105. The rear end 125 of each of the lower conducting arm 124 is thereby secured between one lower plate support surface 148 and the receptacle housing 105.

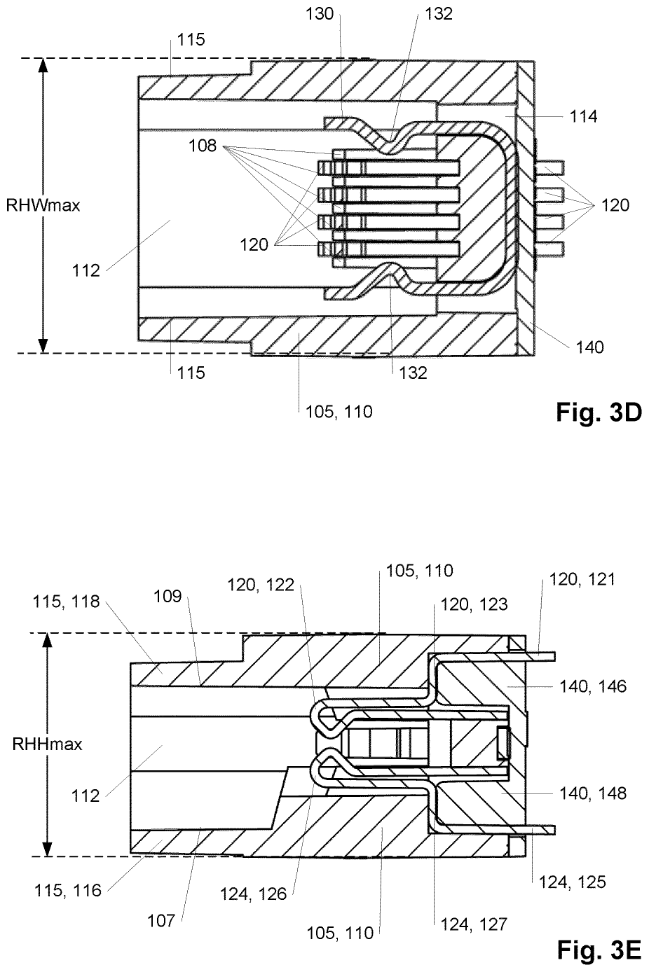

Between the front end 122, 126 and the rear end 121, 125 of the conducting arms 120, 124 are middle sections 123, 127 being bended as compared to the two sections extending straight along the longitudinal direction of the conducting arms 120, 124. The middle sections 123, 127 are also supported by the plate support surfaces 146, 148 and partly by the inside of the receptacle housing 105. The front ends 122, 126 of the conducting arms 120, 124 are not supported by the plate support surfaces 146, 148. The front ends 122 of the upper conducting arms 120 are therefore able to bend away from the front ends 126 of the lower conducting arms 124 thereby allowing the plug plate 30 to fit tightly in between the upper conducting arms 120 and the lower conducting arms 124. This can be seen in FIG. 4B. Thus, the front end 122 of each upper conducting arm 120 and the front end 126 of each lower conducting arm 124 are able to flex away from each other when the plug plate 30 of the multipole plug 1 is inserted between the upper conducting arms 120 and the lower conducting arms 124 when connecting the multipole plug 1 and the multipole receptacle 100.

Between the conducting arms 120, 124 are also found a number of receptacle housing separation parts 106, 108. Bottom receptacle housing separation parts 106 separate each of the lower conducting arms 124. Top receptacle housing separation parts 108 separate each of the upper conducting arms 120. The receptacle housing separation parts 106, 108 provides side-way stability to the conducting arms 120, 124. The receptacle housing separation parts 106, 108 also ensures that the conducting arms 120, 124 do not come in electrical contact with each other. The receptacle housing separation parts 106, 108 are normally part of the receptacle housing 105. Alternatively, the receptacle housing separation parts 106, 108 could be a separate item. The receptacle housing separation parts 106, 108 are most clearly seen in FIGS. 3B and 3F.

The multipole receptacle 100 further comprises a spring 130. The spring 130 is secured in a spring recess 149 in the receptacle insulator plate 140. The spring 130 is extending towards the front end opening 112 of the receptacle housing 105. The spring 130 is configured for securing the multipole plug 1 inside the multipole receptacle 100. The spring 130 has two inwardly bending sections 132, which engages into the side recess section 49 of the plug plate 30. This secures the plug 1 inside the receptacle 100 as shown in FIG. 4A.

The asymmetry of the plug housing front section 15 and the corresponding receptacle housing front section 115 ensures that the plug plate 30 and the conducting arms 120, 124 do not come in contact with each other unless the plug 1 is correctly positioned inside the receptacle 100. The upper conducting arms 120 are therefore positioned closer to the inner upper wall 109 in the front part section 115 of the of receptacle housing 105 than the lower conducting arms 124 are to the inner lower wall 107 in the front part section 115 of the of receptacle housing 105.

The receptacle housing 105 normally has a maximum length (RHLmax) of less than 15 mm, such as less than 12 mm, such as less than 10 mm, such as less than 8 mm, such as 7.55 mm. The receptacle housing 105 normally has a maximum height (RHHmax) of less than 7 mm, such as less than 6 mm, such as less than 5 mm, such as 4.00 mm. The receptacle housing 105 normally has a maximum width (RHWmax) of less than 9 mm, such as less than 8 mm, such as less than 7 mm, such as less than 6 mm, such as 5.30 mm. The dimensions are shown in FIGS. 3A and 3D-3E.

FIGS. 4A-4B show a connected multipole plug 1 of FIG. 1A-1E and receptacle 100 of FIGS. 3A-3F. The spring 130 securing the plug 1 inside the receptacle 100 is shown most clearly in FIG. 4A. The electrical contact between the conducting poles 20, 24 and the conducting arms 120, 124 are seen most clearly in FIG. 4B.

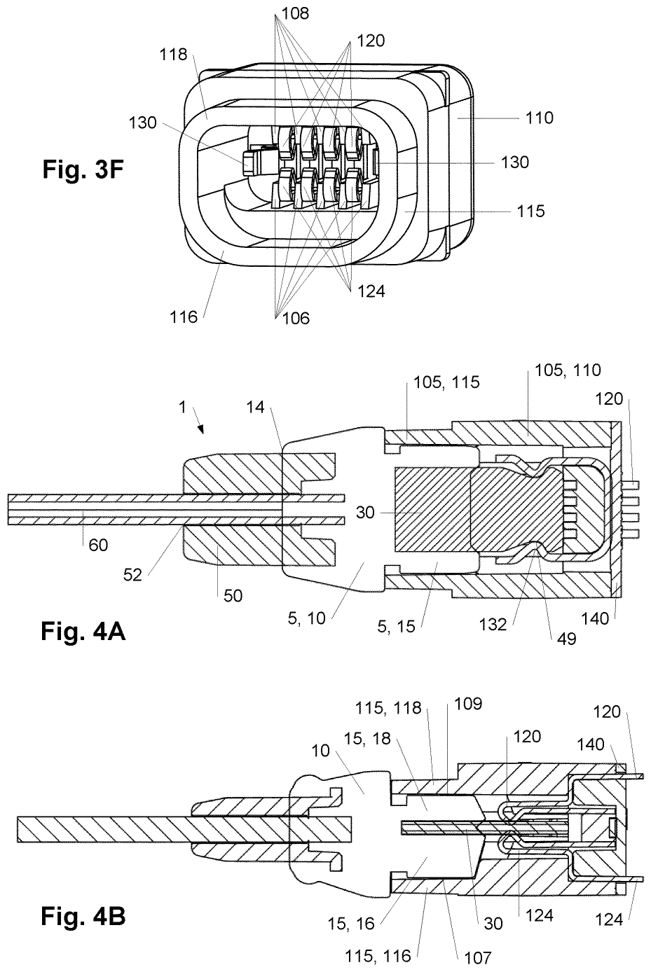

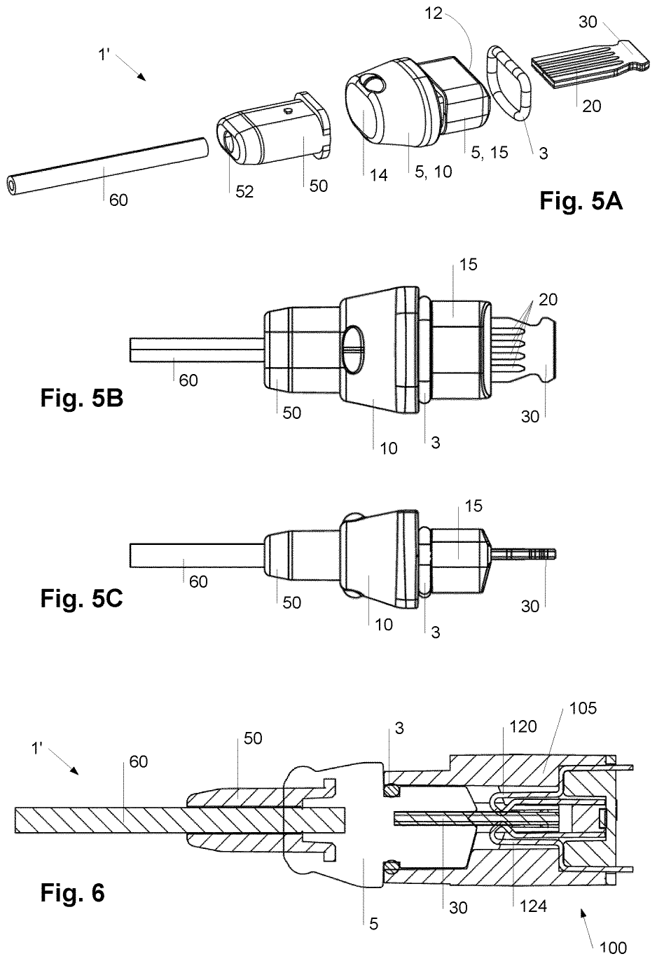

FIGS. 5A-C show an alternative example of the multipole plug 1′. The only difference compared to FIGS. 1A-1E, is that an O-ring 3 is included. the O-ring 3 is positioned between the plug housing rear end section 10 and the plug housing front section 15 as most clearly shown in FIG. 5B. The O-ring 3 ensures a tight fit between the multipole plug 1′ and the multipole receptacle 100 when the two parts are connected as is shown in FIG. 6.

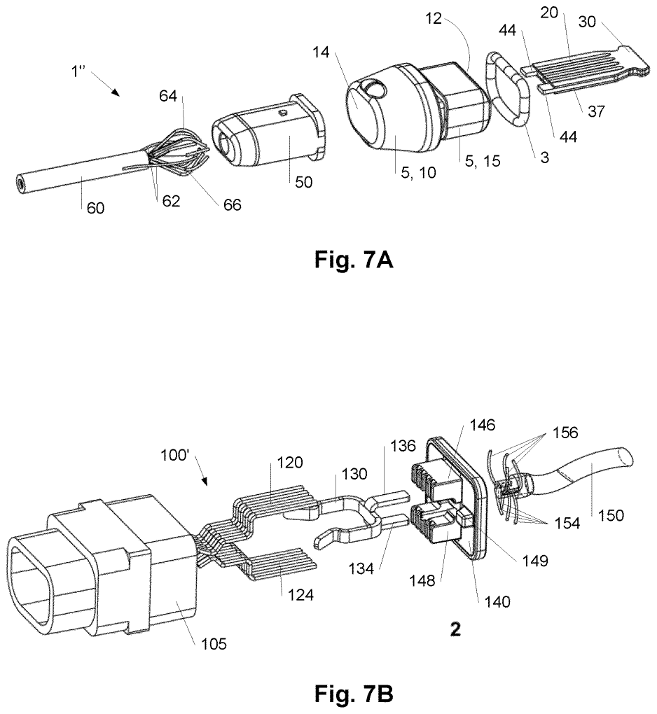

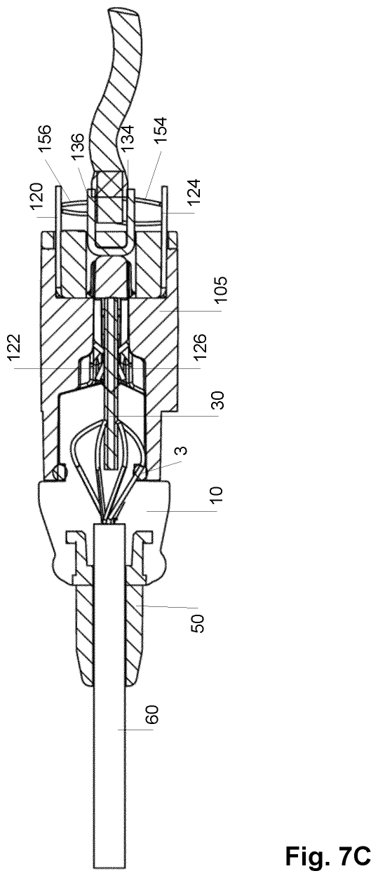

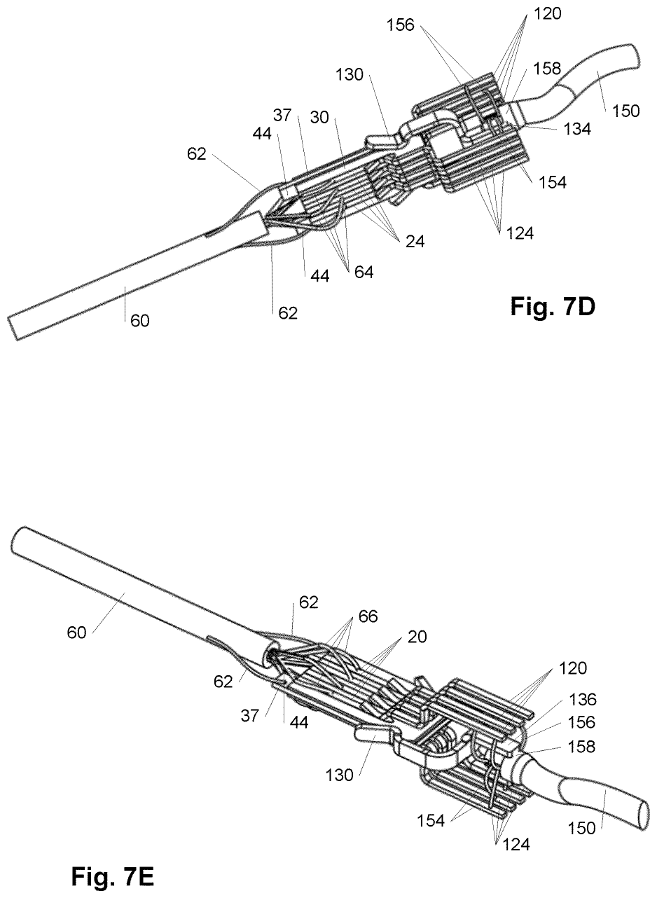

FIG. 7A shows an alternative example of the multipole plug 1″. Compared to FIGS. 5A-C, the middle layer 37 of the plug plate 30 extends further rearwardly having two connecting tabs 44.

As for the other examples shown, the cable 60 comprises a plurality of wires 64, 66 positioned inside the cable (see FIGS. 7D-E). The plurality of wires 64, 66 is configured for being connected to the plurality of upper conducting poles 20 (see FIG. 7E) and the plurality of lower conducting poles 24 (see FIG. 7D), thereby creating an electrical connection. In the example shown in FIG. 7A, the cable 60 further comprises a conductive outer shield layer 62 forming an electrical shield from the plurality of wires 64, 66. The conductive outer shield layer 62 is connected to the conductive middle layer 37 of the plug plate 30 at the connecting tabs 44, thereby creating an electrical connection.

FIG. 7B shows an alternative example of the multipole receptacle 100′. Compared to FIGS. 3A-3F, a receptacle cable 150 is illustrated. The receptacle cable 150 comprises a plurality of receptacle wires 154, 156 configured for being connected to the plurality of upper conducting arms 120 (see FIG. 7E) and the plurality of lower conducting arms 124 (see FIG. 7D), thereby creating an electrical connection (see FIGS. 7C-E). The spring 130 further comprises cable connecting spring parts 134, 136, which connects to a spring conductive shield layer 158. The spring conductive shield layer 158 is shielded from the plurality of receptacle wires 154, 156 positioned inside the receptacle cable 150.

FIG. 7C shows the multipole plug of FIG. 7A connected with the multipole receptacle of FIG. 7B in a side cut-through view (FIG. 7C). A sideways-top view where the outer housing parts have been omitted is shown in FIG. 7D, and a sideways-bottom view where the outer housing parts have been omitted is shown in FIG. 7E. The connection of the plurality of wires 64, 66 with the upper conducting poles 20 and the lower conducting poles 24 on the plug plate 30 is seen in FIGS. 7C-E. The connection of the conductive outer shield layer 62 on the plug cable 60 with the middle layer 37 in the plug plate 30 is seen in FIGS. 7D-E.

Likewise, the connection of the receptacle wires 154, 156 with the upper conducting arm 120 and the lower conducting arm 124 is seen in FIGS. 7C-E and the connection of the spring conductive shield layer 158 with the rear ends 134, 136 of the spring 130 is seen in FIGS. 7D-E.

As an alternative to the receptacle cable 150, a printed circuit board comprising a plurality of connection points configured for being connected to the plurality of upper conducting arms 120, the plurality of lower conducting arms 124, and the spring 130, thereby creating an electrical connection, could also be used.

### REFERENCES

1, 1′, 1″ multipole plug
3 O-ring
5 plug housing
8 funnel plug plate connection section at the front end opening in the plug housing
10 plug housing rear end section
12 front end opening in the plug housing
14 rear end opening in the plug housing
15 plug housing front section
16 bottom plug housing front section of the plug housing front section
17 peripheral bottom plug housing curvature
18 top plug housing front section of the plug housing front section
19 peripheral top plug housing curvature
20 upper conducting poles
24 lower conducting poles
30 plug plate
32 front end of the plug plate
34 rear end of the plug plate
36 top layer of the plug plate
37 middle layer
38 bottom layer of the plug plate
40 front end of the plug plate
42 rear end of the plug plate
44 connecting tab of the middle layer
46 first side of the plug plate
48 second side of the plug plate
49 side recess section
50 cable strain relief
52 through-going opening in the cable strain relief
60 cable
62 conductive outer shield layer
64 inner wire connecting with the lower conducting poles
66 inner wire connecting with the upper conducting poles
100, 100′ multipole receptacle
105 receptacle housing
106 bottom receptacle housing separation part
107 inner lower wall in the receptacle housing
108 top receptacle housing separation part
109 inner upper wall in the receptacle housing
110 receptacle housing rear end section
112 front end opening in the receptacle housing
114 rear end opening in the receptacle housing
115 receptacle housing front section
116 bottom receptacle housing front section of the receptacle housing front section
117 bottom peripheral receptacle housing curvature
118 top receptacle housing front section of the receptacle housing front section
119 top peripheral receptacle housing curvature
120 upper conducting arm
121 rear end of the upper conducting arm
122 front end of the upper conducting arm
123 middle section of the upper conducting arm
124 lower conducting arm
125 rear end of the lower conducting arm
126 front end of the lower conducting arm
127 middle section of the upper conducting arm
130 spring
132 inwardly bending section
134 lower cable connecting spring part connecting with the spring conductive shield layer
136 upper cable connecting spring part connecting with the spring conductive shield layer
140 receptacle insulator plate
141 rear end surface of the receptacle insulator plate
142 upper plate opening in the receptacle insulator plate
144 lower plate opening in the receptacle insulator plate
146 upper plate support surface in the receptacle insulator plate
148 lower plate support surface in the receptacle insulator plate
149 spring recess in the receptacle insulator plate
150 receptacle cable
154 receptacle wire connecting with the lower conducting arm
156 receptacle wire connecting with the upper conducting arm
158 spring conductive shield layer
PLmax maximum plug plate length
PHmax maximum plug plate height
PWmax maximum plug plate width
PWrecess recess plug plate width
HLmax maximum plug housing length
HHmax maximum plug housing height
HWmax maximum plug housing width
HPLmax maximum combined plug housing and plug plate length
RHLmax maximum receptacle housing length
RHHmax maximum receptacle housing height
RHWmax maximum receptacle housing width

1. A multipole plug configured for making electrical contact with parts in a corresponding multipole receptacle when the multipole plug and the multipole receptacle are connected, the multipole plug comprising:
a non-conducting plug housing having a front end opening and a rear end opening;
a cable strain relief extending though the rear end opening of the plug housing, the cable strain relief comprising a through-going relief opening configured for having a cable extending there through;
a plurality of upper conducting poles configured for making electrical contact with a plurality of receptacle upper conducting arms of the multipole receptacle;
a plurality of lower conducting poles configured for making electrical contact with a plurality of receptacle lower conducting arms of the multipole receptacle;
a plug plate extending through the front end opening of the plug housing, wherein the plug plate is substantially flat and comprises:
a non-conducting top layer supporting the plurality of upper conducting poles;
a non-conducting bottom layer supporting the plurality of lower conducting poles;
a maximum plug plate length extending from a front end of the plug plate to a rear end of the plug plate;
a maximum plug plate width extending from a first side of the plug plate to an opposite second side of the plug plate;
a maximum plug plate height extending between the top layer and the bottom layer;
a conductive middle layer positioned between the top surface and bottom surface;
the cable extending through the through-going relief opening of the cable strain relief the cable comprising:
a plurality of wires configured for being connected to the plurality of upper conducting poles and the plurality of lower conducting poles, thereby creating an electrical connection;
at least one conductive outer shield layer forming an electrical shield from the plurality of wires, the at least one conductive outer layer connected to the conductive middle layer of the plug plate, thereby creating an electrical shield or ground connection;
wherein the upper and lower conducting poles are configured for making electrical contact with a plurality of conducting arms in a multipole receptacle when the multipole plug is connected to the multipole receptacle; and
wherein the conductive middle layer of the plug plate is configured for making electrical contact with a conductive spring in the multipole receptacle when the multipole plug is connected to the multipole receptacle;
so that the connection between the conductive middle layer and the conductive spring constitutes a shield or ground connection.

2. A multipole plug configured for making electrical contact with parts in a corresponding multipole receptacle when the multipole plug and the multipole receptacle are connected, the multipole plug comprising:
a non-conducting plug housing having a front end opening and a rear end opening;
a cable strain relief extending though the rear end opening of the plug housing, the cable strain relief comprising a through-going relief opening configured for having a cable extending there through;
a plurality of upper conducting poles configured for making electrical contact with a plurality of receptacle upper conducting arms of the multipole receptacle;
a plurality of lower conducting poles configured for making electrical contact with a plurality of receptacle lower conducting arms of the multipole receptacle;
a plug plate extending through the front end opening of the plug housing, wherein the plug plate is flat and comprises:
a non-conducting top layer supporting the plurality of upper conducting poles;
a non-conducting bottom layer supporting the plurality of lower conducting poles;
a maximum plug plate length extending from a front end of the plug plate to a rear end of the plug plate;
a maximum plug plate width extending from a first side of the plug plate to an opposite second side of the plug plate;
a maximum plug plate height extending between the top layer and the bottom layer;
wherein the plug plate further comprises a side recess section with a recess plug plate width being smaller than the maximum plug plate width and configured for being engaged by a receptacle spring in the multipole receptacle thereby securing the multipole plug in the multipole receptacle.

3. A multipole plug configured for making electrical contact with parts in a corresponding multipole receptacle when the multipole plug and the multipole receptacle are connected, the multipole plug comprising:
a non-conducting plug housing having a front end opening and a rear end opening;
a cable strain relief extending though the rear end opening of the plug housing, the cable strain relief comprising a through-going relief opening configured for having a cable extending there through;
a plurality of upper conducting poles configured for making electrical contact with a plurality of receptacle upper conducting arms of the multipole receptacle;
a plurality of lower conducting poles configured for making electrical contact with a plurality of receptacle lower conducting arms of the multipole receptacle;
a plug plate extending through the front end opening of the plug housing, wherein the plug plate is flat and comprises:
a non-conducting top layer supporting the plurality of upper conducting poles;
a non-conducting bottom layer supporting the plurality of lower conducting poles;
a maximum plug plate length extending from a front end of the plug plate to a rear end of the plug plate;
a maximum plug plate width extending from a first side of the plug plate to an opposite second side of the plug plate;
a maximum plug plate height extending between the top layer and the bottom layer;
wherein the plug housing comprises a plug housing front section configured for being positioned inside a receptacle housing when the multipole plug and the multipole receptacle are connected, wherein the plug plate extends through the plug housing front section dividing the plug housing front section into a bottom plug housing front section extending below the plug plate and a top plug housing front section extending above the plug plate,
wherein the bottom plug housing front section part has a peripheral bottom plug housing curvature being different from a peripheral top plug housing curvature of the top plug housing front section part thereby giving the plug housing front section an asymmetrical periphery.

4. A multipole plug configured for making electrical contact with parts in a corresponding multipole receptacle when the multipole plug and the multipole receptacle are connected, the multipole plug comprising:
a non-conducting plug housing having a front end opening and a rear end opening;
a cable strain relief extending though the rear end opening of the plug housing , the cable strain relief comprising a through-going relief opening configured for having a cable extending there through;
a plurality of upper conducting poles configured for making electrical contact with a plurality of receptacle upper conducting arms of the multipole receptacle;
a plurality of lower conducting poles configured for making electrical contact with a plurality of receptacle lower conducting arms of the multipole receptacle;
a plug plate extending through the front end opening of the plug housing, wherein the plug plate is flat and comprises:
a non-conducting top layer supporting the plurality of upper conducting poles;
a non-conducting bottom layer supporting the plurality of lower conducting poles;
a maximum plug plate length extending from a front end of the plug plate to a rear end of the plug plate;
a maximum plug plate width extending from a first side of the plug plate to an opposite second side of the plug plate;
a maximum plug plate height extending between the top layer and the bottom layer;
wherein the front end opening of the plug housing is tapered inwardly thereby creating a funnel plug plate connection section.

5. The multipole plug according to claim 1, wherein the plug housing comprises a plug housing front section configured for being positioned inside a receptacle housing when the multipole plug and the multipole receptacle are connected, wherein the plug plate extends through the plug housing front section dividing the plug housing front section into a bottom plug housing front section extending below the plug plate and a top plug housing front section extending above the plug plate,
wherein the bottom plug housing front section part has a peripheral bottom plug housing curvature being different from a peripheral top plug housing curvature of the top plug housing front section part thereby giving the plug housing front section an asymmetrical periphery.

6. The multipole plug according to claim 1, wherein the plug plate further comprises a side recess section with a recess plug plate width being smaller than the maximum plug plate width and configured for being engaged by a receptacle spring in the multipole receptacle thereby securing the multipole plug in the multipole receptacle.

7. The multipole plug according to claim 1, wherein the front end opening of the plug housing is tapered inwardly thereby creating a funnel plug plate connection section.

8. The multipole plug according to claim 3, wherein the bottom front section part is thicker than the top front section part.

9. (canceled)

10. (canceled)

11. The multipole plug according to claim 1 further comprising a cable comprising a plurality of wires configured for being connected to the plurality of upper conducting poles and the plurality of lower conducting poles.

12. (canceled)

13. The multipole plug according to claim 1, wherein the plug plate further comprises a middle layer positioned between the top surface and bottom surface, the middle section is a reinforcement layer providing stability to the plug plate.

14. The multipole plug according to claim 13, wherein the reinforcement layer is a metal reinforcement layer.

15. The multipole plug according to claim 1, wherein the plug housing comprises a plug housing rear end section and a plug housing front section, wherein the multipole plug further comprises an O-ring positioned between the plug housing rear end section and the plug housing front section for providing a sealed fit between the plug housing front section positioned inside the multipole receptacle.

16. The multipole plug according to claim 1, wherein the plug housing and plug plate have a combined length of less than 15.0 mm.

17. The multipole plug according to claim 1, wherein the plug housing has a maximum plug housing height of less than 6 mm.

18. The multipole plug according to claim 1, wherein the plug housing has a maximum plug housing width of less than 7.0 mm.

19. The multipole plug according to claim 1, wherein the maximum plug plate length is less than 10.0 mm.

20. The multipole plug according to claim 1, wherein the maximum plug plate width less than 7.0 mm.

21. The multipole plug according to claim 1, wherein the maximum plug plate height is less than 2.0 mm.

22. The multipole plug according to claim 1, wherein the plurality of upper conducting poles is at least four upper conducting poles and the plurality of lower conducting poles is at least four lower conducting poles.

23. (canceled)

24. A multipole receptacle configured for making electrical contact with parts in a corresponding multipole plug when the multipole plug and the multipole receptacle are connected, the multipole receptacle comprising:
a receptacle housing comprising a front end opening and a rear end opening;
a plurality of upper conducting arms configured for making electrical contact with a plurality of upper conducting poles of the multipole plug;
a plurality of lower conducting arms configured for making electrical contact with a plurality of lower conducting poles of the multipole plug;
a receptacle insulator plate positioned in the rear end opening of the receptacle housing, the receptacle insulator plate comprising:
at least one upper plate opening through which the upper conducting arms extend;
at least one lower plate opening through which the lower conducting arms extend;
wherein the multipole receptacle further comprises a spring secured in a spring recess in the receptacle insulator plate, the spring extending towards the front end opening of the receptacle housing, the spring being configured for securing the multipole plug inside the multipole receptacle.

25. (canceled)

26. The multipole receptacle according to claim 24, wherein the receptacle housing comprises a receptacle housing front section inside which a plug housing front section is positioned when the multipole plug and the multipole receptacle are connected, the receptacle housing front section having an inner peripheral surface with a top receptacle housing curvature being different from a bottom receptacle housing curvature thereby giving the inner housing front section an asymmetrical inner periphery.

27. A multipole receptacle configured for making electrical contact with parts in a corresponding multipole plug when the multipole plug and the multipole receptacle are connected, the multipole receptacle comprising:
a receptacle housing comprising a front end opening and a rear end opening;
a plurality of upper conducting arms configured for making electrical contact with a plurality of upper conducting poles of the multipole plug;
a plurality of lower conducting arms configured for making electrical contact with a plurality of lower conducting poles of the multipole plug;
a receptacle insulator plate positioned in the rear end opening of the receptacle housing, the receptacle insulator plate comprising:
at least one upper plate opening through which the upper conducting arms extend;
at least one lower plate opening through which the lower conducting arms extend;
wherein the receptacle housing comprises a receptacle housing front section inside which a plug housing front section is positioned when the multipole plug and the multipole receptacle are connected, the receptacle housing front section having an inner peripheral surface with a top receptacle housing curvature being different from a bottom receptacle housing curvature thereby defining an inner housing front section with an asymmetrical inner periphery.

28. (canceled)

29. The multipole receptacle according to claim 27, further comprising a spring secured in a spring recess in the receptacle insulator plate, wherein the spring is extending towards the front end opening of the receptacle housing, the spring being configured for securing the multipole plug inside the multipole receptacle.

30. (canceled)

31. (canceled)

32. (canceled)

33. The multipole receptacle according to claim 27, wherein the upper conducting arms are closer to an inner upper wall of receptacle housing than the lower conducting arms are to an inner lower wall.

34. The multipole receptacle according to claim 27, wherein the receptacle insulator plate further comprises:
at least one upper plate support surface, wherein a rear end of each upper conducting arm is secured between the least one upper plate support surface and the receptacle housing;
at least one lower plate support surface, wherein a rear end of each lower conducting arm is secured between the least one lower plate support surface and the receptacle housing;
wherein a front end of each upper conducting arm and a front end of each lower conducting arm are able to flex away from each other when the plug plate of the multipole plug is inserted between the upper conducting arms and the lower conducting arms when connecting the multipole plug and the multipole receptacle.

35. The multipole receptacle according to claim 29, wherein the receptacle housing has a maximum length of less than 15 mm.

36. The multipole receptacle according to claim 29, wherein the receptacle housing has a maximum height of less than 7 mm.

37. The multipole receptacle according to claim 29, wherein the receptacle housing has a maximum width of less than 9 mm.

38. A multipole system comprising:
a multipole plug comprising:
a non-conducting plug housing having a front end opening and a rear end opening;
a cable strain relief extending though the rear end opening of the plug housing, the cable strain relief comprising a through-going relief opening configured for having a cable extending there through;
a plurality of upper conducting poles configured for making electrical contact with a plurality of receptacle upper conducting arms of the multipole receptacle;
a plurality of lower conducting poles configured for making electrical contact with a plurality of receptacle lower conducting arms of the multipole receptacle;
a plug plate extending through the front end opening of the plug housing, wherein the plug plate is substantially flat and comprises:
a non-conducting top layer supporting the plurality of upper conducting poles;
a non-conducting bottom layer supporting the plurality of lower conducting poles (24);
a maximum plug plate length extending from a front end of the plug plate to a rear end of the plug plate;
a maximum plug plate width extending from a first side of the plug plate to an opposite second side of the plug plate;
a maximum plug plate height extending between the top layer and the bottom layer;
a conductive middle layer positioned between the top surface and bottom surface;
the cable extending through the through-going relief opening of the cable strain relief, the cable comprising:
a plurality of wires configured for being connected to the plurality of upper conducting poles and the plurality of lower conducting poles, thereby creating an electrical connection;
at least one conductive outer shield layer forming an electrical shield from the plurality of wires, the at least one conductive outer layer connected to the conductive middle layer of the plug plate, thereby creating an electrical connection;
wherein the upper and lower conducting poles are configured for making electrical contact with a plurality of conducting arms in a multipole receptacle when the multipole plug is connected to the multipole receptacle; and
wherein the conductive middle layer of the plug plate is configured for making electrical contact with a conductive spring in the multipole receptacle when the multipole plug is connected to the multipole receptacle;
so that the connection between the conductive middle layer and the conductive spring constitutes a shield or ground connection; and
a multipole receptacle comprising:
a receptacle housing comprising a front end opening and a rear end opening;
a plurality of upper conducting arms configured for making electrical contact with a plurality of upper conducting poles of the multipole plug;
a plurality of lower conducting arms configured for making electrical contact with a plurality of lower conducting poles of the multipole plug;
a receptacle insulator plate positioned in the rear end opening of the receptacle housing, the receptacle insulator plate comprising:
at least one upper plate opening through which the upper conducting arms extend;
at least one lower plate opening through which the lower conducting arms extend;
wherein the receptacle housing comprises a receptacle housing front section inside which a plug housing front section is positioned when the multipole plug and the multipole receptacle are connected, the receptacle housing front section having an inner peripheral surface with a top receptacle housing curvature being different from a bottom receptacle housing curvature thereby defining an inner housing front section with an asymmetrical inner periphery;
wherein the plurality of upper conducting poles of the multipole plug are configured for making electrical contact with the plurality of upper conducting arms of the multipole receptacle, and wherein the plurality of lower conducting poles are configured for making electrical contact with the plurality of lower conducting arms of the multipole receptacle when the multipole plug and the multipole receptacle are connected.

39. The multipole plug according to claim 1, the at least one conductive outer layer connected to the conductive middle layer of the plug plate, thereby creating an electrical shield and ground connection so that the connection between the conductive middle layer and the conductive spring constitutes a shield and ground connection.

40. The multipole receptacle according to claim 27, wherein the receptacle cable further comprises at least one spring conductive shield layer shielded from the plurality of receptacle wires and connected to the spring, thereby creating an electrical connection.
